(19) United States
(12) Patent Application Publication
(10) Pub. No.: US 2021/0271872 A1
(43) Pub. Date: Sep. 2, 2021

(54) Machine Learned Structured Data Extraction From Document Image

(71) Applicant: Uber Technologies, Inc., San Francisco, CA (US)

(72) Inventors: Himaanshu Gupta, Millbrae, CA (US); Xuewen Zhang, Mountain View, CA (US); Jingchen Liu, Cupertino, CA (US); Abi Komma, Mountain View, CA (US); Anupam Dikshit, Santa Clara, CA (US); Mridul Gupta, San Mateo, CA (US); Zejun Huang, Santa Clara, CA (US)

(21) Appl. No.: 17/188,339

(22) Filed: Mar. 1, 2021

Related U.S. Application Data
(60) Provisional application No. 62/983,302, filed on Feb. 28, 2020.

(51) Int. Cl. G06K 9/00; G06K 9/34; G06N 3/04; G06N 20/00

(52) U.S. Cl. CPC G06K 9/00463; G06K 9/344; G06K 2209/01; G06N 20/00; G06N 3/0445

(57) ABSTRACT

A document transcription application receives an image of a document that comprises structured data. The document transcription application performs optical character recognition upon the image of the document to produce a block of text. The document transcription application applies the block of text to a first machine learning model to determine a heat map for a class of data in the structured data in the image of the document. The document transcription application applies the image of the document and the heat map to a second machine learning model to identify a region of the image of the document representing the class of data. The document transcription application generates, using the identified region and the block of text, a structured data file.

### CROSS REFERENCE TO RELATED APPLICATIONS

This application claims the benefit of Provisional Application No. 62/983,302, filed on Feb. 28, 2020, which is incorporated herein by reference.

### TECHNICAL FIELD

The present disclosure relates in general to machine learning and in particular to computer vision and natural language processing.

### BACKGROUND

Structured data is data that resides within fixed fields (or “classes”) of a document, record, or file (“document” herein). For example, a driver's license is a document that has structured data in classes such as “given name,” “surname,” “date of birth,” “license number,” “State,” and so on. Other examples of documents with structured data include restaurant menus, invoices, receipts, and various standardized forms.

Structured data is often manually extracted from images of documents and entered into a software application or database. For example, recruiters at a company may manually enter information from resumes into a database of potential candidates, or users of a software application for local restaurants may manually enter dishes and corresponding prices into the software application. Manual extraction of structured data from documents can be expensive and time consuming, especially when the number of documents is high. Existing optical character recognition and natural language processing technology fails to reliably and autonomously transcribe structured data from images of documents with high accuracy and precision.

### SUMMARY

In an embodiment, a method involves a document transcription application receiving an image of a document that includes structured data of one or more classes. The document transcription application performs optical character recognition upon the image of the document to produce a block of text. The block of text is subdivided into text chunks corresponding to particular locations upon the image of the document identified by bounding boxes.

The method further involves the document transcription application applying the block of text to a first machine learning model to determine a heat map for a class of data in the image of the document. The first machine learning model performs named entity recognition upon the block of text to predict a set of text chunks that contain the class of data, where each text chunk in the block of text is assigned a probability of containing the class of data by the first machine learning model. The document transcription application generates a heat map for predicted locations of the class in the image of the document by matching the set of text chunks to locations upon the document image using the corresponding bounding boxes of the set of text chunks. The heat map is an image channel corresponding to the image of the document, where the value of each pixel of the image channel is the probability of the pixel containing the class of data. The first machine learning model may be a bi-directional long short-term memory neural network with a conditional random field layer.

The method further involves the document transcription application applying the heat map and the image of the document to a second machine learning model to identify a region of the image of the document that contains the class of data. The heat map and the image of the document act as complimentary signals that result in an identified region with greater accuracy and precision than would be obtained solely from the image of the document. The second machine learning model may be a convolutional neural network.

The method further involves the document transcription application generating a structured data file containing the class of data using the output of the second machine learning model. The document transcription application matches the identified region of the image of the document to a particular bounding box of the block of text. The document transcription application records the respective text chunk of the particular bounding box as data of the class of data in the structured data file. The document transcription application may send the structured data file to a computing device, such as a database or a server.

In another embodiment, a non-transitory computer-readable storage medium stores instructions that when executed by a processor causes the processor to execute the above-described method.

In yet another embodiment, a computer system includes a processor and a non-transitory computer-readable storage medium that stores instructions for executing the above-described method.

In an alternative embodiment, the method involves the document transcription application applying the block of text to a graphical neural network, which identifies the region of the image of the document that represents the class of data.

### BRIEF DESCRIPTION OF THE DRAWINGS

FIG. 1 is a block diagram illustrating a system for autonomous document image transcription, according to one embodiment.

FIG. 2 is a data flow diagram for autonomous document image transcription, according to one embodiment.

FIG. 3 is a simplified illustration of class heat map generation, according to one embodiment.

FIG. 4 is a flowchart illustrating a process for autonomous document image transcription, according to one embodiment.

FIG. 5 is a block diagram that illustrates a computer system, according to one embodiment.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality.

### System Environment

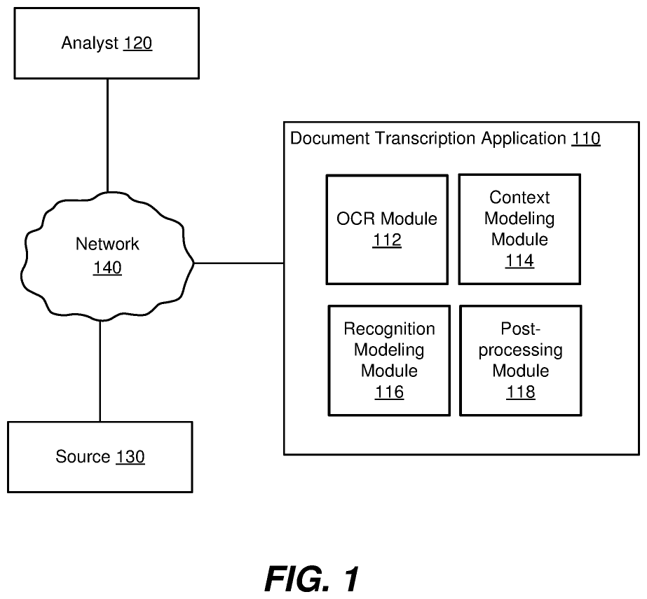

FIG. 1 is a block diagram illustrating a system for autonomous document image transcription, according to one embodiment. The system includes a document transcription application (“DTA”) 110, an analyst 120, and a source 130 coupled to a network 140. Upon receipt of an image of a document from the source 130, the DTA 110 autonomously transcribes the document, extracting structured data and formatting it into a file that the DTA 110 sends to the analyst 120. Depending upon the embodiment, the DTA 110, analyst 120, and/or source 130 may be separate devices or a singular device.

The source 130 is a computing device that sends an image of a document to the DTA 110. For example, the source 130 may be a personal computer, tablet, or smart phone that submits a photo of a menu or a driver's license to the DTA 110. Depending upon the embodiment, there may be multiple sources 130.

The image of the document, or “document image,” is a photo of a document containing structured data of one or more classes. As described herein, a document image contains pixels of three color channels, those being red, green, and blue. However, alternative embodiments may involve document images of alternative numbers or types of color channels, such as a greyscale image containing pixels of one channel, e.g., an intensity of light.

Different types of documents may have different numbers and types of classes. For example, a driver's license may contain some or all of a license number, an expiration date, a state, a first name, a last name, a date of birth, an address, a height, an eye color, a hair color, and a sex. Meanwhile, a menu may contain some or all of an item name, an item description, an item price, and modifiers (such as a discounted rate for particular orders). A document may contain one or more classes of data, and there may be one or more instances of each of the one or more classes of data in the document.

The analyst 120 is a computing device used to access a file of structured data extracted by the DTA 110, and may generate and present one or more user interfaces including the structured data and/or perform one or more analyses using the structured data. Alternatively or additionally, the analyst 120 may be a database to which the file of structured data is sent for storage by the DTA 110. In an embodiment, the analyst 120 is multiple computing devices, such as a database for storage of the file and a computing device for accessing the stored data. Depending upon the embodiment, there may be multiple analysts 120, e.g., multiple computing devices with access to a database that stores files of structured data received from the DTA 110.

The network 140 may comprise any combination of local area and/or wide area networks, using both wired and/or wireless communication systems. In one embodiment, the network 140 uses standard communications technologies and/or protocols. For example, the network 140 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, all or some of the communication links of the network 140 may be encrypted using any suitable technique or techniques. The analyst 120, source 130, and DTA 110 exchange data among one another via the network 140.

### Document Transcription Application

The DTA 110 automatically transcribes document images into structured data files. The DTA 110 includes an Optical Character Recognition (“OCR”) module 112, a context modeling module 114, a recognition modeling module 116, and a post-processing module 118. The DTA 110 receives an image of a document from the source 130 and transcribes it into a file including structured data extracted from the image of the document. For example, the file may be a JavaScript Object Notation (“JSON”) Object. The DTA 110 may send the file to the analyst 120 for storage, analysis and/or presentation.

The OCR module 112 performs optical character recognition on the image of the document. This results in an unstructured block of text, a “text block,” extracted from the image. The OCR module 112 sends the text block to the context modeling module 114. In an embodiment, the OCR module 112 sends the document image to the context modeling module 114.

The text block contains one or more text chunks, each of which is a subset of the text in the text block. Different text chunks are associated with different locations upon the document image, e.g., in terms of pixels of the document image from which the characters of the text chunk were extracted, and/or in terms of a bounding box enclosing the text chunk. For example, a text chunk extracted from the image of the document may be associated with a particular set of pixels of the image containing the text chunk, or with a set of pixels or coordinates that define a bounding box enclosing the text chunk.

The OCR module 112 performs optical character recognition using one or more techniques, depending upon the embodiment. For example, the OCR module 112 may employ matrix matching or feature extraction techniques, or a two-pass technique with adaptive recognition. In an embodiment, the OCR module 112 uses TESSERACT for optical character recognition. In an alternative embodiment, the OCR module 112 uses the GOOGLE CLOUD VISION API.

In an embodiment, the order in which the OCR 112 identifies text in the document image and adds it to the text block proceeds according to a preset direction, e.g., as set by the analyst 120 or an implementer of the DTA 110. For example, the OCR 112 may first perform optical character recognition to generate bounding boxes for text chunks in the document image, then write each text chunk into the text block according to the order of the bounding boxes. For example, the OCR 112 may write text chunks into the text block such that bonding boxes are evaluated from left to right and from the top of the document image to the bottom of the document image. In this manner, text in the document image may be entered into the text block sequentially.

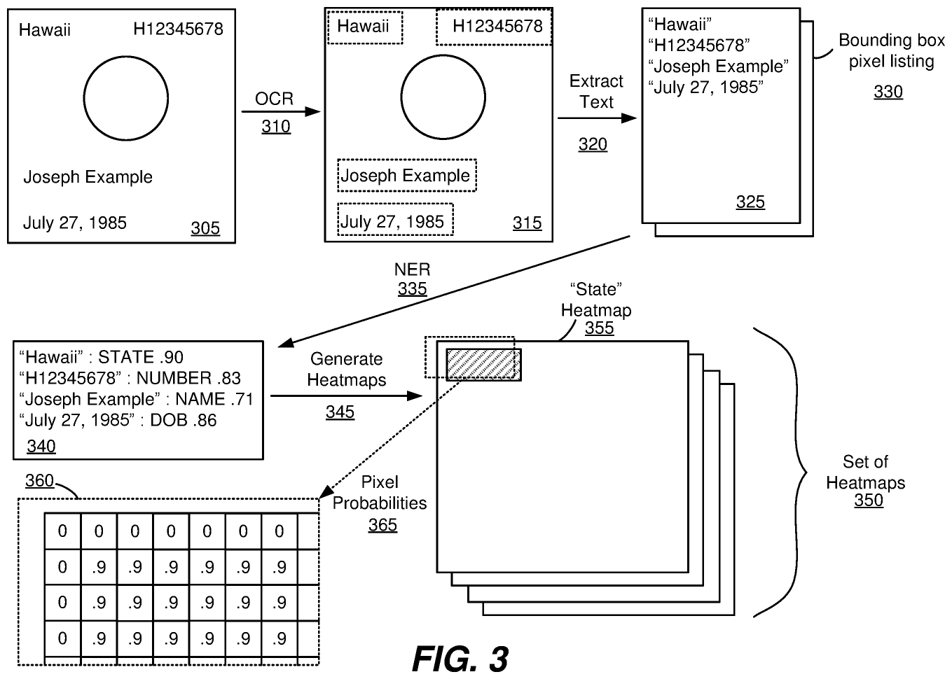

The context modeling module 114 generates heat maps for structured data classes, which is illustrated in greater detail below with reference to FIG. 3. The context modeling module 114 includes a first machine learning model that performs named entity recognition. The context modeling module 114 applies the text block to the first machine learning model. The first machine learning model receives as input the block of text extracted from the document image by the OCR 112 and outputs, for each text chunk and each class for which the model is trained, a probability that the text chunk is data of the class. For example, the first machine learning model may predict a text chunk “Callie” is 84% likely to be a first name, 10% likely to be a last name, 5% likely to be a State, 1% likely to be a license number, and 0% likely to be a date of birth. The probability that a text chunk belongs to a class may be output by the first machine learning model as a value between 0 and 1, e.g., 0.84 for 84%.

Depending upon the embodiment, the first machine learning model is trained to make predictions for different numbers of classes. For example, the first machine learning model may be trained to predict the likelihood that a text chunk belongs to one class, or it may be trained to predict the likelihood that a text chunk belongs to each of a dozen classes. The first machine learning model may be trained on labeled training data. The labeled training data may be one or more blocks of text with text chunks labeled by class. In an embodiment, the first machine learning model is a bi-directional long short-term memory (“LSTM”) neural network with a conditional random field (“CRF”) layer.

The context modeling module 114 generates, for each class on which the first machine learning model is trained, a heat map representing the likelihood that a pixel of the document image contains data of the class. The heat map for a class is an image channel corresponding to the image of the document, where the value of each pixel of the image channel is the probability of the pixel containing the class of data.

The context modeling module 114 generates a heat map for a class by identifying each text chunk with at least a threshold probability of corresponding to the class, as determined by the first machine learning model. Alternatively, the context modeling module 114 may identify each text chunk for which the probability that the text chunk was of the class was greater than any other probabilities assigned to the text chunk for other classes. In yet another alternative embodiment, the context modeling module 114 identifies all text chunks for the purpose of generating a heat map, regardless of probability value.

For each identified text chunk, the context modeling module 114 identifies the set of pixels corresponding to the text chunk or the pixels contained within the bounding box corresponding to the text chunk. The context modeling module 114 identifies the corresponding pixels of the heat map and assigns those pixels the probability value of the text chunk produced by the first machine learning model. In an embodiment, each pixel of a heat map that is not assigned the probability value of a text chunk is assigned a probability value of 0.

As a specific example, a text block may contain two text chunks. The first text chunk occupies a first ten pixels of a document image, and the second text chunk occupies a second ten pixels of the document image. The first machine learning model may assign the first text chunk a probability value of 0.9 for a “name” class and a probability value of 0.1 for a “state” class. The first machine learning model may assign the second text chunk a probability value of 0.2 for “name” and 0.8 for “state.” As such, in the heat map for “name,” the context modeling module 114 may assign each of the first ten pixels the value 0.9 and the second ten pixels the value of 0.2. In contrast, in the heat map for “state,” the context modeling module 114 may assign each of the first ten pixels the value 0.1, and the second ten pixels the value 0.8.

Depending upon the embodiment, the context modeling module 114 may modify one or more of the probability values in a heat map. For example, the context modeling module 114 may perform an arithmetic operation upon the probability values to scale them, or the context modeling module 114 may overwrite probability values of less than a threshold value with a secondary value, such as 0, or the context modeling module 114 may overwrite probability values of at least a threshold value with a secondary value, such as 1.

The context modeling module 114 sends the one or more generated heat maps to the recognition modeling module 116.

The recognition modeling module 116 receives as input the document image and one or more heat maps, which it applies to a second machine learning model that performs computer vision. The second machine learning model outputs a set of regions of the document image, where each region in the set of regions corresponds to a particular identified class and includes one or more pixels. The sets of regions output of the second machine learning model include, for each region of each set, a probability value representing a probability that the region contains data of the respective class of the region, as predicted by the second machine learning model.

In an embodiment, the second machine learning model of the recognition modeling module 116 is a multimodal convolutional neural network (“CNN”). The second machine learning model is trained on images of documents with labeled bounding boxes or pixels for classes in the images as well as respective heat maps. Depending upon the embodiment, the second machine learning model may be trained to output one or more types of sets of regions, e.g., responsive to a number of classes for which the model has been trained. For example, if the model is trained to identify “first name” classes and “surname” classes in the image, the second machine learning model outputs two sets of regions, one corresponding to instances of the “first name” class in the image and a second corresponding to instances of the “surname” class in the image.

The document image and one or more heat maps input to the second machine learning model act as complimentary signals. On average, a machine learning model to which is input a document image and a heat map for a class can identify a region in the document image corresponding to the class with greater accuracy and precision than a machine learning model to which is input solely a document image. As such, results obtained using the techniques described herein provide for greater accuracy and precision of regions in an image of a document where data is predicted to be of a particular class. The recognition modeling module 116 sends the sets of regions to the post-processing module 118.

The post-processing module 118 uses sets of regions from the recognition modeling module 116 and blocks of text from the OCR module 112 to generate structured data. The post-processing module 118 may perform one or more intermediate steps to further process a set of regions before generating structured data. For example, the post-processing module 118 may remove a region if no text chunk has a bounding box containing pixels with at least a threshold amount of overlap with the pixels of the region. For example, if no bounding box overlaps at least 70% with the region, the post-processing module 118 removes the region from the respective set of regions. Additionally, the post-processing module 118 may remove regions with a probability value below a threshold probability value. For example, is the post-processing module 118 determines that a region has a probability value indicating less than 70%, the post-processing module 118 removes the region from the respective set of regions. In an embodiment, if, for a class, no region has at least the threshold probability needed to not be removed, the post-processing module 118 sends a notification to the analyst 120 that structured data of the class could not be extracted from the document image.

The post-processing module 118 may include rules for each class which are verified by checking the text chunks corresponding to the bounding boxes that overlap the regions for that class. As a particular example, a “price” class may correspond to a rule that text chunks corresponding to bounding boxes that overlap the regions from the set of regions corresponding to the “price” class cannot contain letters. As such, if the post-processing module 118 identifies a region corresponding to the “price” class is overlapped by a bounding box for a text chunk that contains letters, the region is removed from the set of regions. Additionally, the post-processing module 118 may eliminate duplicate regions in a set of regions, e.g., regions that overlap at least a threshold amount.

In an embodiment, the post-processing module 118 for one or more classes, the post-processing module 118 eliminates from the respective set of regions all regions except for a certain number of regions of highest probability. For example, the post-processing module 118 may retain, for a set of regions, only the region with the highest probability value, or only the two regions with the two highest probability values. A specific example of the former is for “license number”, where the post-processing module 118 only retains one region, as there is only one license number on the driver's license.

After performing the one or more intermediate steps, the post-processing module 118 generates structured data by matching bounding boxes of text chunks from the block of text to the regions in the sets of regions. For example, for a region corresponding to a “name” class, the post-processing module 118 may identify a bounding box for the text chunk “Joseph Example” overlapping at least a threshold number or percentage of pixels as the region, and therefore include in the structured data the text “Joseph Example” for the “name” class. In an embodiment, the generated structured data is a JavaScript Object Notation (“JSON”) file. Depending upon the embodiment, the DTA 110 sends the structured data to the analyst 120.

For example, the structured data file may store the structured data as attribute-value pairs, such as the following for an example driver's license:

{

“name”: “Joseph Example”,
“dateofbirth”: “July27,1995”,
“state”: “Hawaii”,
“id”: “H12345678”

}

In an embodiment, the DTA 110 includes a single neural network that receives as input the text block and outputs a probability that each word in the text block belongs to each of one or more classes, depending upon the number of classes for which the single neural network is trained. The single neural network may be a graph neural network (“GNN”). The GNN may be trained on text blocks where each word is labeled with a class of data.

The DTA 110 performs word embedding upon each word of the block of text to generate a set of word embeddings. A word embedding is a vector representing the word. Each word embedding is used by the DTA 110 as a node and the DTA 110 connects the nodes using edges to form a graph. In an embodiment, the graph is a fully connected graph, where each node is connected to all other nodes. Alternatively, the DTA 110 may use one or more heuristics to connect nodes. For example, words in the same row of text or column of text may be connected, or words within a threshold distance of one another are connected, where the distance between words is determined by the DTA 110 using the bounding boxes of each word.

The DTA 110 applies the graph to the GNN, which generates as output an updated word embedding for each node in the graph. Each of the output word embeddings not only contains information for the respective word itself, but also local context from nearby words learned by the model. A second layer of the GNN takes as input the output word embeddings and generates, for each word embedding, a probability that the word embedding belongs to each of one or more classes. The DTA 110 uses the produced probabilities of the word embeddings as the probabilities for the respective words of the text block.

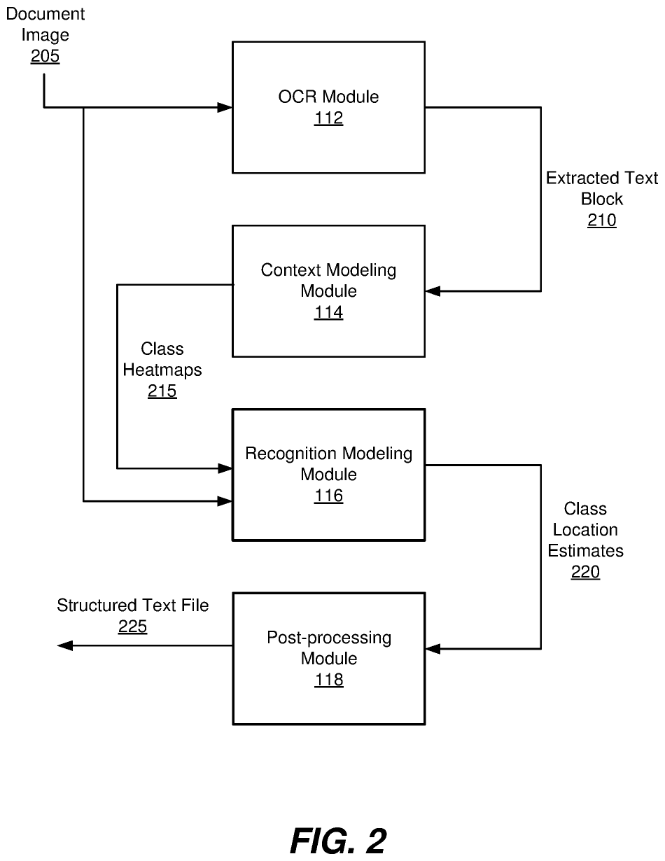

FIG. 2 is a data flow diagram for autonomous document image transcription, according to one embodiment. The OCR module 112 receives a document image 205 and outputs an extracted text block 210. The extracted text block is input to the context modeling module 114, which outputs a set of heatmaps, one for each class 215. The recognition modeling module 116 receives as input the heatmaps 215 and the document image 205 and outputs class location estimates 220, e.g., the sets of regions. The post-processing module 118 receives as input the class location estimates 220 and outputs the structured text file 225.

FIG. 3 is a simplified illustration of class heat map generation, according to one embodiment. The document image is a driver's license 305. The driver's license 305 has structured text including a state name “Hawaii,” a license number “H1234678”, a name “Joseph Example,” and a date of birth “Jul. 27, 1985”. The DTA 110 performs OCR 310 upon the driver's license 305 to extract text 320. The DTA 110 identifies text in the driver's license 305, places bounding boxes around each text chunk 315, and writes the text contained in each bounding box into a text block 325. The DTA 110 tracks the pixels contained by each bounding box 330.

The DTA 110 performs named entity recognition 335 upon the text block, e.g., using the first machine learning model. This produces, for each text chunk and each class, a probability that the text chunk belongs to the class. This is illustrated with each text chunk being associated with its highest probability class 340, such as “H12345678” having a highest probability value for being a license number, at 0.83 or 83%.

The DTA 110 generates heatmaps 345 using the probability values and the text block. For example, for a “State” heatmap 355, the DTA 110 identifies a set of pixels in the heat map corresponding to the pixels contained by the bounding box for the text chunk “Hawaii”. As the heat map is a channel with the same number of pixels as the document image, an X^{th} pixel in the document image is the X^{th} pixel in the heat map. Each pixel in the heat map identified as corresponding to a pixel in the bounding box is assigned the probability value of the respective text chunk—as, in this example, the text chunk is “Hawaii”, each of the corresponding pixels in the “state” heat map is assigned the probability value 0.9. The DTA 110 repeats this for one or more bounding boxes for each heat map in the set of heat maps 350. For example, in an embodiment, the text chunk “Joseph Example” has a probability value of 0.07 for the “state” class, and so the pixels in the state heat map corresponding to the bounding box for “Joseph Example” are assigned the value 0.07.

### Process

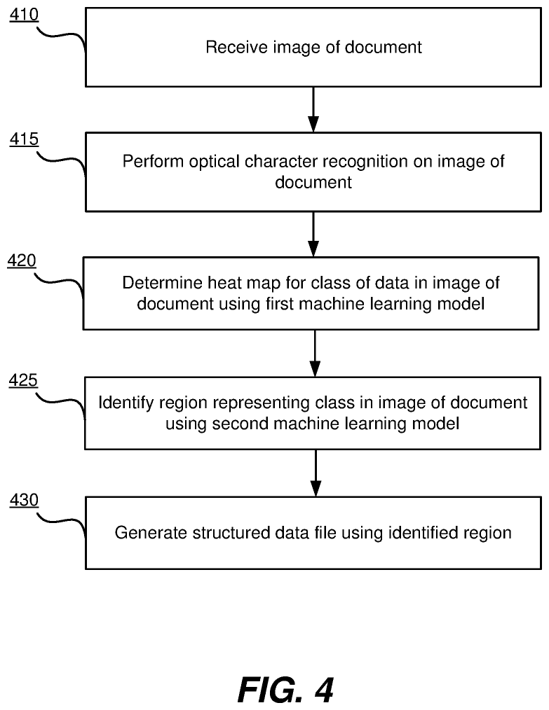

FIG. 4 is a flowchart illustrating a process for autonomous document image transcription, according to one embodiment. The DTA 110 receives 410 an image of a document from the source 130. The DTA 110 performs 415 optical character recognition upon the image of the document. This produces a text block including one or more text chunks, each corresponding to a set of pixels in the document image. The set of pixels may be specified in terms of a bounding box that contains the pixels representing the text of the text chunk in the document image.

The DTA 110 determines 420 one or more heat maps corresponding to one or more classes of data in the image of the document using a first machine learning model. The DTA 110 applies the text block to the first machine learning model to generate probabilities that each text chunk corresponds to each class. The DTA 110 uses the generated probabilities to generate heat maps for each class, where the heat map for a class includes the probability of a text chunk at one or more pixels in the heat map corresponding to pixels of the bounding box of the text chunk.

The DTA 110 identifies 425 regions representing specific classes in the image or the document using a second machine learning model. The DTA 110 applies the one or more heat maps and the document image to the second machine learning model to generate, for each class, a set of regions where data of the respective class is predicted to exist within the document image.

The DTA 110 generates 430 a structured data file using the identified regions. The DTA 110 may first perform one or more intermediate steps to pare down or otherwise modify the sets of regions. The DTA 110 then matches, for each class, one or more of the regions of the respective set of regions to one or more text chunks from the text block, based on overlap between the regions and the bounding boxes of the text chunks. The DTA 110 associates the text of the matched text blocks with the class of the respective matched regions, then adds the text to the structured data file 430 in association with the classes, e.g., as attribute-value pair entries. The DTA 110 may send the structured data file to the analyst 120.

### Computer Hardware

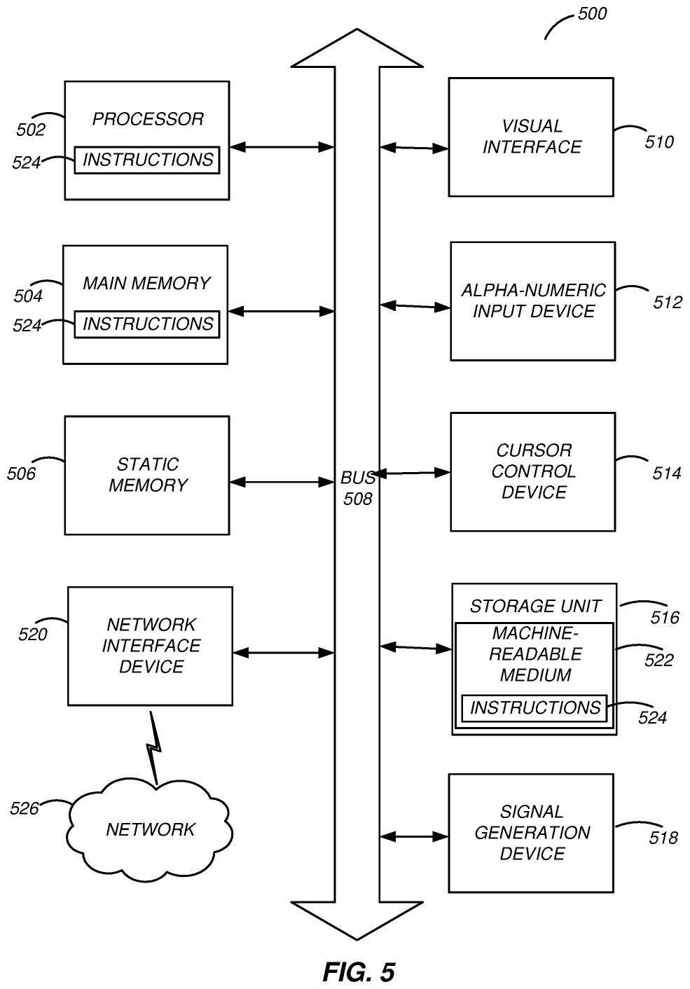

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500. The computer system 500 can be used to execute instructions 524 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally processor 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 500 also includes a main memory 504. The computer system may include a storage unit 516. The processor 502, memory 504 and the storage unit 516 communicate via a bus 508.

In addition, the computer system 506 can include a static memory 506, a display driver 510 (e.g., to drive a plasma display panel (PDP), a liquid crystal display (LCD), or a projector). The computer system 500 may also include alphanumeric input device 512 (e.g., a keyboard), a cursor control device 514 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store the instructions 524. The term “machine-readable medium” shall also be taken to include any medium that is capable of storing instructions 524 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The Figures (FIGS.) and the accompanying description describe certain embodiments by way of illustration only. One skilled in the art will readily recognize from the following description that alternative embodiments of the structures and methods illustrated herein may be employed without departing from the principles described herein. Reference is made to several embodiments, examples of which are illustrated in the accompanying figures. It is noted that wherever practicable similar or like reference numbers may be used in the figures and may indicate similar or like functionality.

The description has been presented for the purpose of illustration; it is not intended to be exhaustive or to limit the invention to the precise forms disclosed. Persons skilled in the relevant art can appreciate that many modifications and variations are possible in light of the above disclosure.

Aspects of the invention, such as software for implementing the processes described herein, may be embodied in a non-transitory tangible computer readable storage medium or any type of media suitable for storing electronic instructions which may be coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention.

What is claimed is:

1. A method for creating a structured data file, the method comprising:
receiving, by a computing device, an image of a document that comprises structured data;
performing, by the computing device, optical character recognition upon the image of the document to produce a block of text;
applying, by the computing device, the block of text to a first machine learning model to determine a heat map for a class of data in the structured data in the image of the document;
applying, by the computing device, the image of the document and the heat map to a second machine learning model to identify a region of the image of the document representing the class of data; and
generating, by the computing device, using the identified region and the block of text, a structured data file.

2. The method of claim 1, further comprising:
sending, by the computing device, the structured data file to a secondary computing device.

3. The method of claim 1, wherein applying, by the computing device, the block of text to the first machine learning model to determine the heat map for the class of data in the structured data in the image of the document, comprises:
generating, by the computing device, using the first machine learning model, for a text chunk that is a subset of the text comprising the text block, a probability that the text chunk is data of the class of data;
identifying, by the computing device, a portion of the image of the document corresponding to the text chunk; and
assigning, by the computing device, the probability to each pixel in the heat map corresponding to the portion of the image.

4. The method of claim 1, wherein generating, by the computing device, using the identified region and the block of text, the structured data file, comprises:
performing, by the computing device, an intermediate step to process the identified region.

5. The method of claim 1, wherein generating, by the computing device, using the identified region and the block of text, the structured data file, comprises:
matching, by the computing device, the identified region to a text chunk that is a subset of the text comprising the text block; and
adding the text chunk to the structured data file in association with the class as an attribute-value pair.

6. The method of claim 1, wherein the first machine learning model is a bi-directional long short-term memory neural network with a conditional random field (“CRF”) layer, and the second machine learning model is a multimodal convolutional neural network.

7. The method of claim 1, further comprising:
generating, by the computing device, a probability that the identified region comprises structured data of the class of data;
determining, by the computing device, that the probability does not exceed a threshold probability; and
sending, by the computing device, to a secondary computing device, a notification that structured data of the class of data could not be extracted from the image of the document.

8. A non-transitory computer-readable storage medium storing computer program instructions executable by a processor to perform operations for creating a structured data file, the operations comprising:
receiving, by a computing device, an image of a document that comprises structured data;
performing, by the computing device, optical character recognition upon the image of the document to produce a block of text;
applying, by the computing device, the block of text to a first machine learning model to determine a heat map for a class of data in the structured data in the image of the document;
applying, by the computing device, the image of the document and the heat map to a second machine learning model to identify a region of the image of the document representing the class of data; and
generating, by the computing device, using the identified region and the block of text, a structured data file.

9. The non-transitory computer-readable storage medium of claim 8, the operations further comprising:
sending, by the computing device, the structured data file to a secondary computing device.

10. The non-transitory computer-readable storage medium of claim 8, wherein applying, by the computing device, the block of text to the first machine learning model to determine the heat map for the class of data in the structured data in the image of the document, comprises:
generating, by the computing device, using the first machine learning model, for a text chunk that is a subset of the text comprising the text block, a probability that the text chunk is data of the class of data;
identifying, by the computing device, a portion of the image of the document corresponding to the text chunk; and
assigning, by the computing device, the probability to each pixel in the heat map corresponding to the portion of the image.

11. The non-transitory computer-readable storage medium of claim 8, wherein generating, by the computing device, using the identified region and the block of text, the structured data file, comprises:
performing, by the computing device, an intermediate step to process the identified region.

12. The non-transitory computer-readable storage medium of claim 8, wherein generating, by the computing device, using the identified region and the block of text, the structured data file, comprises:
matching, by the computing device, the identified region to a text chunk that is a subset of the text comprising the text block; and
adding the text chunk to the structured data file in association with the class as an attribute-value pair.

13. The non-transitory computer-readable storage medium of claim 8, wherein the first machine learning model is a bi-directional long short-term memory neural network with a conditional random field (“CRF”) layer, and the second machine learning model is a multimodal convolutional neural network.

14. The non-transitory computer-readable storage medium of claim 8, the operations further comprising:
generating, by the computing device, a probability that the identified region comprises structured data of the class of data;
determining, by the computing device, that the probability does not exceed a threshold probability; and
sending, by the computing device, to a secondary computing device, a notification that structured data of the class of data could not be extracted from the image of the document.

15. A system, comprising:
a processor; and
a non-transitory computer-readable storage medium storing computer program instructions executable by a processor to perform operations for creating a structured data file, the operations comprising:
receiving, by a computing device, an image of a document that comprises structured data;
performing, by the computing device, optical character recognition upon the image of the document to produce a block of text;
applying, by the computing device, the block of text to a first machine learning model to determine a heat map for a class of data in the structured data in the image of the document;
applying, by the computing device, the image of the document and the heat map to a second machine learning model to identify a region of the image of the document representing the class of data; and
generating, by the computing device, using the identified region and the block of text, a structured data file.

16. The system of claim 15, the operations further comprising:
sending, by the computing device, the structured data file to a secondary computing device.

17. The system of claim 15, wherein applying, by the computing device, the block of text to the first machine learning model to determine the heat map for the class of data in the structured data in the image of the document, comprises:
generating, by the computing device, using the first machine learning model, for a text chunk that is a subset of the text comprising the text block, a probability that the text chunk is data of the class of data;
identifying, by the computing device, a portion of the image of the document corresponding to the text chunk; and
assigning, by the computing device, the probability to each pixel in the heat map corresponding to the portion of the image.

18. The system of claim 15, wherein generating, by the computing device, using the identified region and the block of text, the structured data file, comprises:
performing, by the computing device, an intermediate step to process the identified region.

19. The system of claim 15, wherein generating, by the computing device, using the identified region and the block of text, the structured data file, comprises:
matching, by the computing device, the identified region to a text chunk that is a subset of the text comprising the text block; and
adding the text chunk to the structured data file in association with the class as an attribute-value pair.

20. The system of claim 15, wherein the first machine learning model is a bi-directional long short-term memory neural network with a conditional random field (“CRF”) layer, and the second machine learning model is a multimodal convolutional neural network.
